(19) United States
(12) Patent Application Publication
(10) Pub. No.: US 2026/0320148 A1
(43) Pub. Date: Oct. 15, 2026

(54) OPERATION DEVICE AND OPERATION METHOD FOR FLEXIBLY PERFORMING NUMBER THEORETIC TRANSFORM

(71) Applicant: Industrial Technology Research Institute, Hsinchu (TW)

(72) Inventors: Chih-Cheng Lu, Hsinchu City (TW); Chung-Han Lee, Hsinchu County (TW); Cheng-Ming Shih, Hsinchu County (TW)

(73) Assignee: Industrial Technology Research Institute, Hsinchu (TW)

(21) Appl. No.: 19/264,842

(22) Filed: Jul. 9, 2025

(30) Foreign Application Priority Data
Apr. 14, 2025 (TW) 114113948

(51) Int. Cl. G06F 17/14

(52) U.S. Cl. CPC G06F 17/144

(57) ABSTRACT

An operation method for flexibly performing number theoretic transform, including: initializing internal parameters of an in-memory computing macro circuit, and preloading a plurality of weight coefficients corresponding to each stage in a flexible bit-width NTT stage circuit; storing metadata in one of two memory blocks; generating a control signal through a control logic circuit to enable the flexible bit-width NTT stage circuit to sequentially perform an NTT stage operation on each flexible bit-width butterfly operation circuit, until completing the NTT stage operation for all the flexible bit-width butterfly operation circuits, wherein the NTT stage operation includes NTT and inverse NTT stage calculations; repeatedly performing a calculation of the number of stages corresponding to the number of points required for the NTT stage operation through the flexible bit-width NTT stage circuit; and outputting a number theoretic transform result from the memory block that last receives data among the two memory blocks.

### CROSS-REFERENCE TO RELATED APPLICATION

This application claims the priority benefit of Taiwan application serial no. 114113948, filed on Apr. 14, 2025. The entirety of the above-mentioned patent application is hereby incorporated by reference herein and made a part of this specification.

### TECHNICAL FIELD

The disclosure relates to an operation device and operation method for flexibly performing number theoretic transform.

### BACKGROUND

In lattice-based post-quantum cryptosystem, number theoretic transform (NTT) based on butterfly operation for implementing polynomial multiplication is one of the mainstream methods in current post-quantum cryptography (PQC) encryption and decryption algorithms, such as CRYSTALS-Kyber and CRYSTALS-Dilithium. However, these algorithms use many different combinations of modulus Q and bit-width, as shown in the following Table 1.

| Type | Cryptosystem | N | q | #bits of q |
|---|---|---|---|---|
| Signature | Falcon | 512 | 12289 | 14 |
| | | 1024 | 12289 | 14 |
| | Dilithium | 256 | 8380417 | 23 |
| | Kyber | 256 | 3329 | 12 |
| Key Encapsulation | Saber | 256 | 2¹³, 2¹⁰ | 13 |
| Mechanism(KEM) | NTRU | 509 | 2048 | 11 |
| | | 701 | 8192 | 13 |
| | NTRU Prime | 653 | 4621 | 13 |
| | | 1277 | 7897 | 13 |
| | FrodoKEM | 640 | 2¹⁵ | 15 |
| | | 1344 | 2¹⁶ | 16 |

Taking CRYSTALS-Kyber and CRYSTALS-Dilithium with the same N=256-point NTT as examples, CRYSTALS-Kyber uses 12 bit input and Q=3329 while CRYSTALS-Dilithium uses 23 bit input and Q=8380417. In existing NTT systems, most adopt fixed bit-width length for implementation, and perform addition, subtraction, and multiplication operations corresponding to the modulus Q value. However, different modulus Q will affect all addition, subtraction, and multiplication operation results in NTT, leading to fixed bit-width NTT being unable to be universally applied in both CRYSTALS-Kyber and CRYSTALS-Dilithium systems. An NTT fixed at 12 bit input with modulus Q=3329 cannot be used to apply to systems requiring an NTT module with a bit-width of 23 bit and modulus Q=8380317, because all mod add, mod sub, and multiplication results calculated through modulus Q=3329 are different from the results using Q=8380417.

In the US patent (application No. U.S. Ser. No. 18/819,499) proposed by the same inventors of this case, a number theoretic transform calculation and an inverse number theoretic transform calculation may be implemented to reduce the number of butterfly operation circuits based on a simplified butterfly operation architecture through ping-pong sorting operation method, such that the calculation result of butterfly operation may be accessed based on improved memory access mechanism, achieving higher access efficiency and data correctness.

The inventors of this case propose improvements to the number theoretic transform stage circuit based on the operation device of the aforementioned US patent (application No. U.S. Ser. No. 18/819,499). In order to enhance the flexibility of the number theoretic transform (NTT) module in practical applications, the variable bit-width number theoretic transform stage (NTT stage) module may define input and output bit-width and corresponding Q value (modulus) in response to different encryption and decryption algorithms. The flexible bit-width universal NTT/INTT of this case may improve the limitations of existing fixed bit-width NTT/INTT modules in algorithm applications with different bit-widths.

### SUMMARY

The disclosure provides an operation device for flexibly performing number theoretic transform, including two memory blocks, a flexible bit-width number theoretic transform stage (NTT Stage) circuit, a sorting circuit, and a control logic circuit. One of the two memory blocks is configured to store metadata. The flexible bit-width NTT stage circuit has a plurality of weight coefficients corresponding to each stage, and includes a plurality of flexible bit-width butterfly operation circuits and a division-by-two circuit, wherein each flexible bit-width butterfly operation circuit includes an in-memory computing macro circuit, a Barrett reduction circuit, and a modulo adder and modulo subtractor circuit. The in-memory computing macro circuit has internal parameters, and is configured to preload the plurality of weight coefficients corresponding to each stage in the flexible bit-width NTT stage circuit. The sorting circuit is coupled to the two memory blocks and the flexible bit-width NTT stage circuit. The control logic circuit is coupled to the flexible bit-width NTT stage circuit, and configured to generate a control signal to enable the flexible bit-width NTT stage circuit to sequentially perform an NTT stage operation on each flexible bit-width butterfly operation circuit, until completing the NTT stage operation for all the flexible bit-width butterfly operation circuits, wherein the NTT stage operation includes an NTT stage calculation and an inverse NTT stage calculation, and the flexible bit-width NTT stage circuit performs the NTT stage calculation and inverse NTT stage calculation. The flexible bit-width NTT stage circuit reads the metadata and input data from one of the two memory blocks, wherein one of the two memory blocks is the memory block that last receives data among the two memory blocks. When the NTT stage calculation is the NTT stage calculation, the flexible bit-width NTT stage circuit performs the NTT stage calculation on the metadata and input data to obtain a calculation result, the sorting circuit sorts the calculation result to obtain a sorting result of the calculation result, and the other one of the two memory blocks stores the sorting result. When the NTT stage calculation is the inverse NTT stage calculation, the sorting circuit sorts the input data to obtain sorted inverse number theoretic transform input data, the flexible bit-width NTT stage circuit performs the inverse NTT stage calculation on the inverse number theoretic transform input data and metadata to obtain the calculation result, and the other one of the two memory blocks stores the calculation result. The flexible bit-width NTT stage circuit repeatedly performs a calculation of the number of stages corresponding to the number of points required for the NTT stage operation. When the flexible bit-width NTT stage circuit completes the calculation of the number of stages corresponding to the number of points required for the NTT stage operation, the flexible bit-width NTT stage circuit outputs a number theoretic transform result from the memory block that last receives data among the two memory blocks.

In an embodiment of the disclosure, when the NTT stage operation is the NTT stage calculation, the flexible bit-width NTT stage circuit is further configured to read first data from the input data and the weight coefficient corresponding to the stage so as to perform a multiplication operation to obtain a first multiplication result corresponding to the stage through the in-memory computing macro circuit, perform Barrett reduction based on the first multiplication result and metadata to obtain a first post-modulo result through the Barrett reduction circuit, calculate a first modadd result and a first modsub result based on the metadata, second data and first post-modulo result through the modulo adder and modulo subtractor circuit, and output the first modadd result and first modsub result to the sorting circuit.

In an embodiment of the disclosure, when the NTT stage operation is the inverse NTT stage calculation, the flexible bit-width NTT stage circuit is further configured to calculate a second modadd result and a second modsub result corresponding to the stage based on the metadata and first data and second data in the inverse number theoretic transform input data through the modulo adder and modulo subtractor circuit, read the second modsub result and weight coefficients corresponding to the stage so as to perform a multiplication operation to obtain a second multiplication result through the in-memory computing macro circuit, perform Barrett reduction based on the second multiplication result and metadata to obtain a second post-modulo result through the Barrett reduction circuit, calculate two divide-by-two results based on the second post-modulo result, second modadd result and metadata through the division-by-two circuit, and output the two divide-by-two results to one of the two memory blocks.

In an embodiment of the disclosure, the Barrett reduction circuit is further configured to receive a selection value to select different Barrett reduction modules.

In an embodiment of the disclosure, the Barrett reduction module uses CRYSTAL-Kyber algorithm or CRYSTAL-Dilithium algorithm.

The disclosure also provides an operation method for flexibly performing number theoretic transform, adapted for an operation device, wherein the operation device includes two memory blocks, an NTT stage circuit, a sorting circuit, and a control logic circuit. The flexible bit-width NTT stage circuit includes a plurality of flexible bit-width butterfly operation circuits and a division-by-two circuit, wherein each flexible bit-width butterfly operation circuit includes an in-memory computing macro circuit, a Barrett reduction circuit, and a modulo adder and modulo subtractor circuit. The operation method for flexibly performing number theoretic transform includes: initializing internal parameters of the in-memory computing macro circuit, and preloading a plurality of weight coefficients corresponding to each stage in the flexible bit-width NTT stage circuit; storing metadata in one of the two memory blocks; generating a control signal through the control logic circuit to enable the flexible bit-width NTT stage circuit to sequentially perform an NTT stage operation on each flexible bit-width butterfly operation circuit, until completing the NTT stage operation for all the flexible bit-width butterfly operation circuits, wherein the NTT stage operation includes an NTT stage calculation and an inverse NTT stage calculation, the NTT stage calculation and inverse NTT stage calculation may be performed through the flexible bit-width NTT stage circuit, and the steps of the NTT stage operation include: reading the metadata and input data from one of the two memory blocks, wherein one of the two memory blocks is the memory block that last receives data among the two memory blocks; when the NTT stage operation is the NTT stage calculation, performing the NTT stage calculation on the metadata and input data to obtain a calculation result through the flexible bit-width NTT stage circuit, sorting the calculation result through the sorting circuit to obtain a sorting result of the calculation result, and storing the sorting result in the other one of the two memory blocks; and when the NTT stage operation is the inverse NTT stage calculation, sorting the metadata to obtain sorted inverse number theoretic transform input data through the sorting circuit, performing the inverse NTT stage calculation on the inverse number theoretic transform input data and metadata to obtain the calculation result through the flexible bit-width NTT stage circuit, and storing the calculation result in the other one of the two memory blocks; and repeatedly performing a calculation of the number of stages corresponding to the number of points required for the NTT stage operation through the flexible bit-width NTT stage circuit; and after completing the calculation of the number of stages corresponding to the number of points required for the NTT stage operation through the flexible bit-width NTT stage circuit, outputting a number theoretic transform result from the memory block that last receives data among the two memory blocks.

Based on the above, the operation device and operation method for flexibly performing number theoretic transform provided by the disclosure may use the flexible bit-width n-bit modulo adder and modulo subtractor circuit, the Barrett reduction circuit, the division-by-two circuit, and the NTT stage circuit composed of the in-memory computing macro circuit for performing multiplication operations, in conjunction with the dual memory buffers for data exchange and the sorting circuit to achieve flexible bit-width NTT stage operation.

### BRIEF DESCRIPTION OF THE DRAWINGS

The accompanying drawings are included to provide a further understanding of the disclosure, and the accompanying drawings are incorporated in and constitute a part of this specification. The drawings illustrate the exemplary embodiments of the disclosure, and together with the description, serve to explain the principle of the disclosure.

FIG. 1 is a block diagram illustrating an operation device for flexibly performing number theoretic transform according to an embodiment of the disclosure.

FIG. 2 is a block diagram illustrating a flexible bit-width NTT stage circuit according to an embodiment of the disclosure.

FIG. 3 is a circuit diagram illustrating an in-memory computing macro circuit according to an embodiment of the disclosure.

FIG. 4 is a circuit diagram illustrating a Barrett reduction circuit according to an embodiment of the disclosure.

FIG. 5 is a circuit diagram illustrating a modulo adder and modulo subtractor circuit according to an embodiment of the disclosure.

FIG. 6 is a circuit diagram illustrating a division-by-two circuit according to an embodiment of the disclosure.

FIG. 7 is a flowchart illustrating an operation method 3 for flexibly performing number theoretic transform according to an embodiment of the disclosure.

FIG. 8 is a flowchart illustrating performing the NTT stage (NTT) calculation as displayed in step S332 of the operation method for flexibly performing number theoretic transform according to an embodiment of the disclosure.

FIG. 9 is a schematic diagram illustrating performing the NTT stage (NTT) calculation as displayed in step S332 of the operation method for flexibly performing number theoretic transform according to an embodiment of the disclosure.

FIG. 10 is an architecture diagram illustrating a flexible bit-width 256-point NTT stage circuit NTT according to an embodiment of the disclosure.

FIG. 11 is a flowchart illustrating performing inverse NTT stage (INTT) calculation as displayed in step S335 of an operation method for flexibly performing number theoretic transform according to an embodiment of the disclosure.

FIG. 12 is a schematic diagram illustrating performing inverse NTT stage (INTT) calculation as displayed in step S335 of the operation method 3 for flexibly performing number theoretic transform according to an embodiment of the disclosure.

FIG. 13 is an architecture diagram illustrating a flexible bit-width 256-point inverse NTT stage circuit INNT according to an embodiment of the disclosure.

### DETAILED DESCRIPTION OF DISCLOSURED EMBODIMENTS

Some exemplary embodiments of the disclosure will be described in detail in conjunction with the accompanying drawings. When the same reference numbers appear in different drawings, they will be regarded as the same or similar elements. These exemplary embodiments are only a part of the disclosure and do not disclose all possible implementation manner provided in the disclosure. More precisely, these exemplary embodiments are merely examples of the methods, devices and systems in the patent claims of the disclosure.

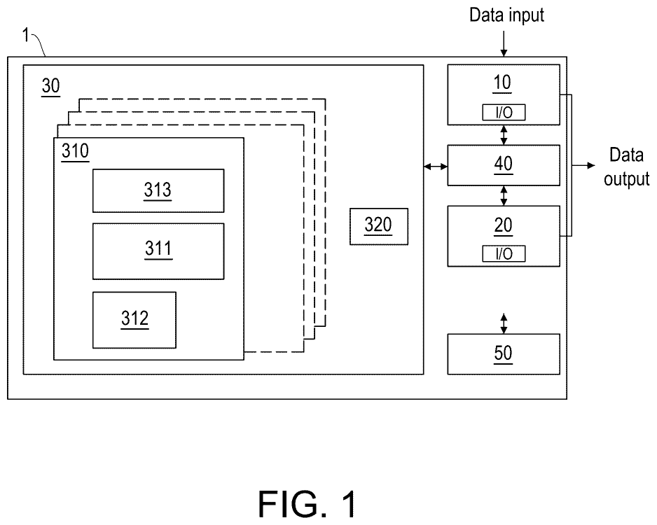

FIG. 1 is a block diagram illustrating an operation device 1 for flexibly performing number theoretic transform according to an embodiment of the disclosure. The operation device 1 includes a memory block 10, a memory block 20, a flexible bit-width NTT stage circuit 30, a sorting circuit 40, and a control logic circuit 50.

The control logic circuit 50 is coupled to the memory block 10 which stores metadata, the memory block 20, the flexible bit-width NTT stage circuit 30, and the sorting circuit 40. In practice, the control logic circuit 50 may be a central processing unit (CPU), a micro-processor, or an embedded controller. The memory block 10 and the memory block 20 are, for example, static random-access memory (SRAM) blocks, dynamic random access memory (DRAM) blocks, or other memory blocks, which are not limited by the disclosure.

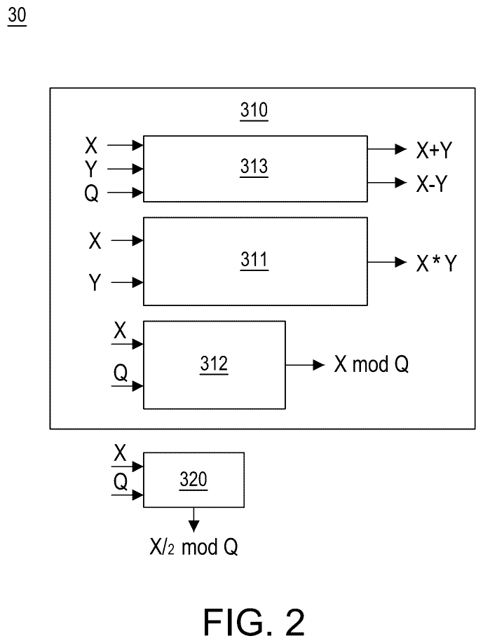

FIG. 2 is a block diagram illustrating the flexible bit-width NTT stage circuit 30 according to an embodiment of the disclosure. As shown in FIG. 2, the function of the flexible bit-width NTT stage circuit 30 is to perform Barrett reduction to obtain number theoretic transform result/inverse number theoretic transform result, that is, to compute the results of each stage in number theoretic transform (NTT)/inverse number theoretic transform (INTT) operations. The Barrett reduction includes CRYSTAL-Kyber and CRYSTAL-Dilithium.

The flexible bit-width NTT stage circuit 30 includes a plurality of flexible bit-width butterfly operation circuits 310 and a division-by-two (n-bit div2) circuit 320. Each flexible bit-width butterfly operation circuit 310 includes an in-memory computing macro circuit 311, a Barrett reduction circuit 312, and a modulo adder and modulo subtractor circuit 313.

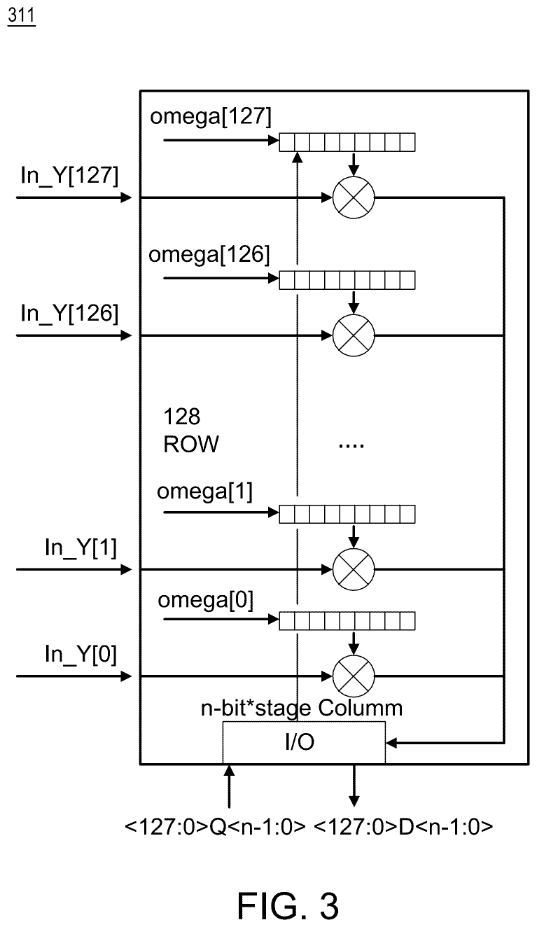

FIG. 3 is a circuit diagram illustrating the in-memory computing macro circuit 311 according to an embodiment of the disclosure. The flexible bit-width in-memory computing macro circuit 311 may store weight coefficients omega[0]-omega[127] of 256 points required for 8 stages, which functions to perform multiplication operations. The in-memory computing macro circuit 311 has internal parameters and is configured to preload the plurality of weight coefficients omega[0]-omega[127] corresponding to each stage in the flexible bit-width NTT stage circuit. When the in-memory computing macro circuit 311 is used for multiplication operations, it may simultaneously input a plurality of points of first data In_Y[0]-In_Y[127] to the in-memory computing macro circuit 311 to perform multiplication with weight coefficients omega[0]-omega[127], and output first multiplication results D[0]-D[127].

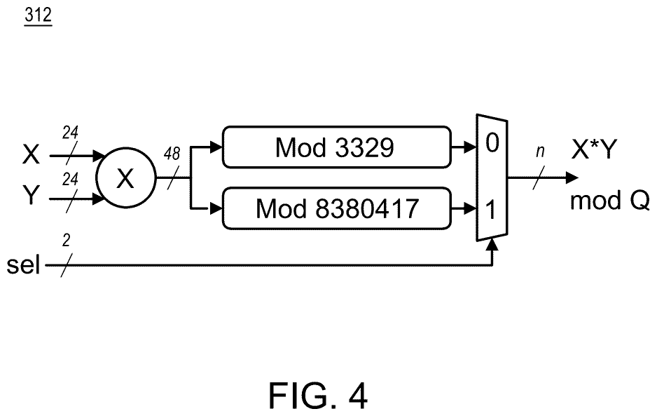

FIG. 4 is a circuit diagram illustrating the Barrett reduction circuit 312 according to an embodiment of the disclosure. The flexible bit-width Barrett reduction circuit 312 is composed of a modulo 3329 (24 bit input) module and a modulo 8380417 (46 bit input) module, used for Barrett reduction after performing multiplication operations through the in-memory computing macro circuit 311. It may support two sets of Barrett reduction modules for modulo 3329 or modulo 8380417 after 24 bit*24 bit multiplication operations, where the modulo 3329 and modulo 8380417 Barrett reduction modules use the Barrett reduction modules of CRYSTALS-Kyber and CRYSTALS-Dilithium algorithms respectively. In an embodiment, in order to save hardware area and cost of the Barrett reduction circuit 312, the Barrett reduction circuit 312 may adopt left and right shift circuits to replace multiplication and division operations. In an embodiment of the disclosure, the control logic circuit 50 is further configured to input a selection value (sel) to the Barrett reduction circuit 312 to select different Barrett reduction (modulo 3329 (24 bit input) modules and a modulo 8380417 (46 bit input) module), which may support operations after 24 bit*24 bit multiplication. The in-memory computing macro circuit 311 coupled with the Barrett reduction circuit 312 may be set to support multiplication of data up to a maximum of 24 bit, and in the 256-point NTT/INTT operation, 24 bit weight coefficients for 8 stages may be pre-stored.

The number of stages in NTT/INTT is determined by the number of points. Generally, in NTT operations with powers of 2, the number of stages equals log₂ N (where N is the number of points), but the CRYSTALS-Kyber algorithm is an exception with one fewer stage. For example, traditional 256-point NTT/INTT requires 8 stages to complete the calculation, but Kyber's NTT/INTT has 7 stages. This NTT stage module and its sub-modules all have flexible bit-width. By changing the bit-width and Q value, they may be applied to different encryption and decryption algorithms, such as: CRYSTALS-Kyber (12 bit input, Q=3329) and CRYSTALS-Dilithium (23 bit input, Q=8380417).

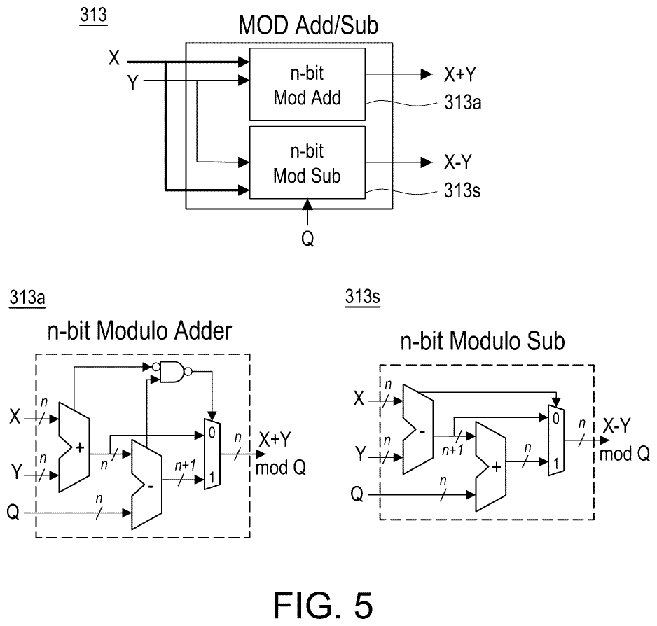

FIG. 5 is a circuit diagram illustrating the modulo adder and modulo subtractor circuit 313 according to an embodiment of the disclosure. The flexible bit-width modulo adder and modulo subtractor circuit 313 includes an n-bit modulo adder 313a and an n-bit modulo sub 313s. The input bit number may be changed, using n-bit modulo addition/modulo subtraction to achieve modulo addition and modulo subtraction operations, where the bit-width of addition and subtraction needs to be greater than or equal to the bit number of the Q value.

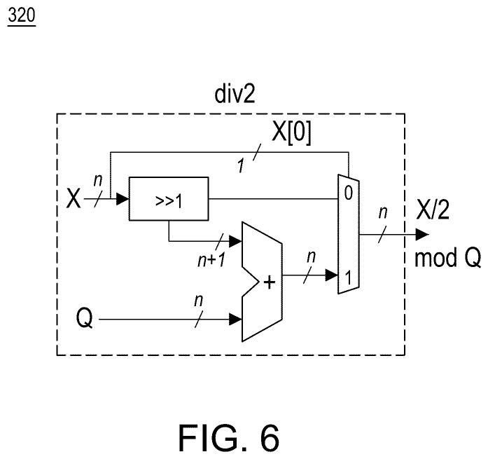

FIG. 6 is a circuit diagram illustrating the division-by-two circuit 320 according to an embodiment of the disclosure. When the NTT stage operation is inverse NTT stage (INTT) calculation, the flexible bit-width division-by-two circuit 320 is configured to perform division by two operation, where the computed value is the input value (X) divided by 2 and then modulo Q (X/2 mod Q). The lowest bit of the input value is used to determine whether it is odd or even. If it is even, the input value is directly right-shifted by 1 bit for output; if it is odd, the input value is right-shifted by 1 bit and then added with Q/2 value for output. In an embodiment, the sorting circuit 40 is coupled to the two memory blocks 10, 20 and the flexible bit-width NTT stage circuit 30. The disclosure uses the flexible bit-width NTT stage circuit 30, which processes n-bit modulo addition and modulo subtraction operations through the flexible bit-width modulo adder and modulo subtractor circuit 313, and performs n-bit multiplication operations in conjunction with the in-memory computing macro circuit 311. Following the multiplication operation, modulo Q for different Q values may be performed through the flexible bit-width Barrett reduction circuit 312. Finally, for the division by two operation required by INTT, the flexible bit-width division-by-two (n-bit div2) circuit 320 is used, which not only avoids using dividers to save hardware area but also completes modulo Q simultaneously. Combined with the design of the general-purpose sorting circuit 40, the flexible bit-width NTT stage unit, and the dual memory block architecture for ping-pong sorting operations as proposed in the US patent (application number U.S. Ser. No. 18/819,499) by the same inventor of this case, calculation for N-point NTT may be completed in as few as log₂ N clock cycles using N/2 flexible bit-width butterfly operation circuits 310.

In an embodiment, the control logic circuit 50 is coupled to the flexible bit-width NTT stage circuit 30 and configured to generate a control signal to enable the flexible bit-width NTT stage circuit 30 to sequentially perform the NTT stage operation for each flexible bit-width butterfly operation circuit 310, until completing the NTT stage operation for all the flexible bit-width butterfly operation circuits 310.

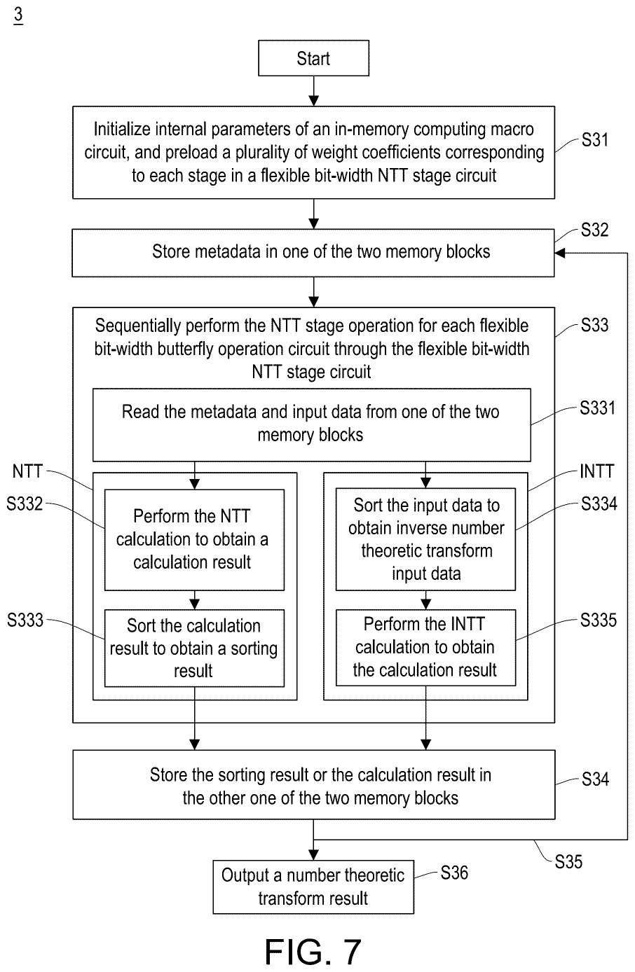

FIG. 7 is a flowchart illustrating an operation method 3 for flexibly performing number theoretic transform according to an embodiment of the disclosure. The operation method 3 of FIG. 7 may be performed by the control logic circuit 50 of the operation device 1 in FIG. 1, where the operation method 3 includes steps S31-S36. In the following, please refer to FIG. 1 to FIG. 7 at the same time.

In step S31, the internal parameters of the in-memory computing macro circuit 311 are initialized, and a plurality of weight coefficients omega[0]-omega[127] corresponding to each stage in the flexible bit-width NTT stage circuit 30 are preloaded.

In step S32, a metadata Q is stored in one of the two memory blocks 10, 20 (for example, memory block 10).

In step S33, a control signal is generated through the control logic circuit 50 to enable the flexible bit-width NTT stage circuit 30 to sequentially perform the NTT stage operation for each flexible bit-width butterfly operation circuit 310, until completing the NTT stage operation for all the flexible bit-width butterfly operation circuits 310.

In detail, the NTT stage operation includes an NTT stage (NTT) calculation and an inverse NTT stage (INTT) calculation, and the flexible bit-width NTT stage circuit 30 may perform the NTT stage calculation and the inverse NTT stage calculation. Specifically, by means of the flexible bit-width NTT stage circuit 30, n-bit NTT/INTT stage operation may be completed. Through the control signal issued by the control logic circuit 50, the two memory blocks, i.e., the memory block 10 and memory block 20, and a ping-pong memory mechanism for resorting, all NTT/INTT stage operations of N points may be completely performed.

Therefore, when performing the NTT stage operation in step S33, the flexible bit-width NTT stage circuit 30 will first read the metadata Q and input data from one of the two memory blocks 10, 20 (for example, memory block 10), namely step S331.

Next, when the flexible bit-width NTT stage circuit 30 processes the NTT stage (NTT) calculation, in step S332, the NTT stage (NTT) calculation may be performed on the metadata Q and input data to obtain a calculation result through the flexible bit-width NTT stage circuit 30, with details to be described later. In step S333, the calculation result may be sorted to obtain a sorting result of the calculation result through the sorting circuit 40. Then, in step S34, the sorting result may be stored in the other one of the two memory blocks 10, 20 (for example, memory block 20).

Alternatively, when the flexible bit-width NTT stage circuit 30 processes the inverse NTT stage (INTT) calculation, in step S334, the input data may be sorted to obtain sorted inverse number theoretic transform input data through the sorting circuit 40. In step S335, the inverse NTT stage (INTT) calculation may be performed on the inverse number theoretic transform input data and metadata Q to obtain the calculation result through the flexible bit-width NTT stage circuit 30, with details to be described later. Then, in step S34, the calculation result may be stored in the other one of the two memory blocks 10, 20 (for example, memory block 20).

In step S35, the calculation of the number of stages corresponding to the number of points required for the NTT stage operation is repeatedly perform through the flexible bit-width NTT stage circuit 30, that is, the process returns to step S32, and steps S32-S35 are performed. Specifically, for the calculation result stored in the other one of the two memory blocks 10, 20 (for example, memory block 20) in step S34, when performing the next NTT stage operation, the flexible bit-width NTT stage circuit 30 will read the metadata Q and input data from one of the two memory blocks 10, 20 (for example, memory block 20). By analogy, through the two memory blocks, i.e., the memory block 10 and memory block 20, and a ping-pong memory mechanism for resorting, all NTT/INTT stage operations of N points may be completely performed.

In step S36, after completing the calculation of the number of stages corresponding to the number of points required for the NTT stage operation through the flexible bit-width NTT stage circuit 30, the number theoretic transform result may be output from the memory block that last receives data among the two memory blocks 10, 20 (which may be memory block 10 or memory block 20).

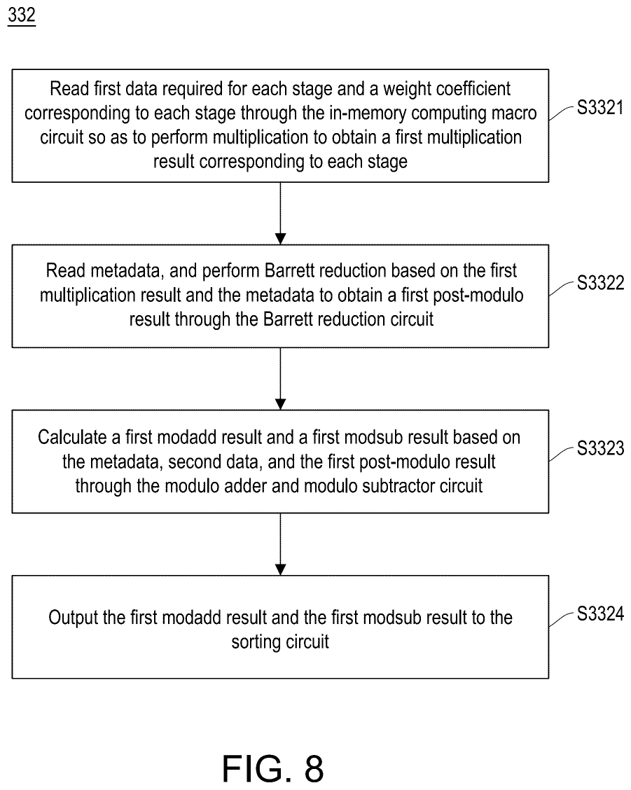

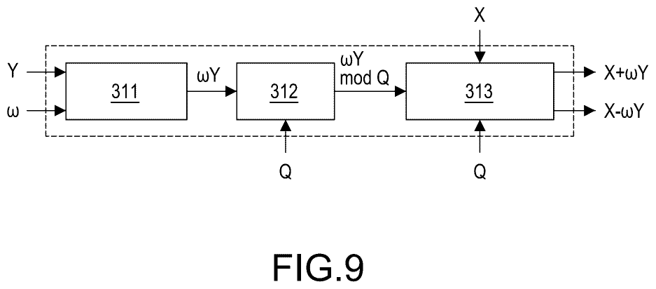

Next, an explanation will be provided for the step of performing the NTT stage (NTT) calculation to obtain the calculation result as displayed in step S332 of the operation method 3 illustrated in FIG. 7 through the flexible bit-width NTT stage circuit 30. FIG. 8 is a flowchart illustrating performing the NTT stage (NTT) calculation as displayed in step S332 of the operation method 3 for flexibly performing number theoretic transform according to an embodiment of the disclosure. FIG. 9 is a schematic diagram illustrating performing the NTT stage (NTT) calculation as displayed in step S332 of the operation method 3 for flexibly performing number theoretic transform according to an embodiment of the disclosure. The NTT calculation in FIG. 8 and FIG. 9 may be performed by the control logic circuit 50 of the operation device 1 in FIG. 1, where the NTT calculation includes steps S3321-S3324. In the following, please refer to FIG. 1 and FIG. 8 and FIG. 9 at the same time.

In step S3321, first data Y from the input data and a weight coefficient ω corresponding to the stage may be read so as to perform a multiplication operation Y*ω to obtain a first multiplication result ωY corresponding to the stage through the in-memory computing macro circuit 311. Specifically, the internal memory block (not shown in the figure) in the in-memory computing macro circuit 311 may pre-store the first data Y required for the stage and the weight coefficient ω corresponding to the stage. Through the in-memory computing macro circuit 311, the first data Y required for the stage and the weight coefficient ω corresponding to each stage may be read from the internal memory block, and the two may be multiplied to calculate the first multiplication result ωY corresponding to the stage.

In step S3322, the metadata Q is read from the memory block 10, and Barrett reduction may be performed based on the first multiplication result ωY and the metadata Q to obtain a first post-modulo result of ωY, i.e., ωY mod Q through the Barrett reduction circuit 312.

In step S3323, a first modadd result X+ωY and a first modsub result X−ωY may be calculated based on the metadata Q, second data X, and the first post-modulo result ωY mod Q through the modulo adder and modulo subtractor circuit 313.

In step S3324, the control logic circuit 50 outputs the first modadd result X+ωY and the first modsub result X−ωY to the sorting circuit 40.

When the control logic circuit 50 outputs the first modadd result X+ωY and the first modsub result X−ωY to the sorting circuit 40, the process returns to step S333 in FIG. 3, and the calculation result may be sorted through the sorting circuit 40 to obtain the sorting result of the calculation result.

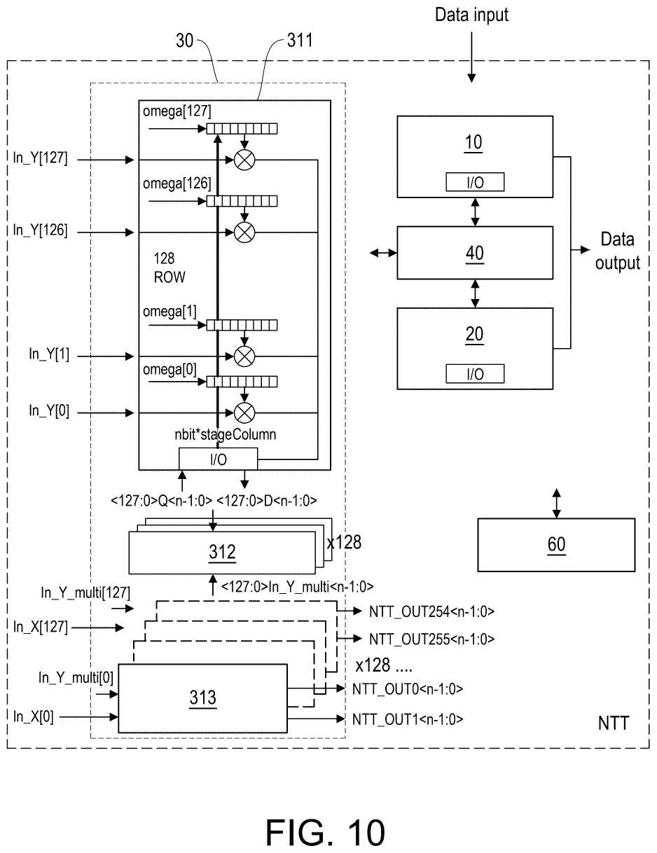

FIG. 10 is an architecture diagram illustrating a flexible bit-width 256-point NTT stage circuit NTT according to an embodiment of the disclosure. As shown in FIG. 10, the flexible bit-width NTT stage circuit 30 reads metadata Q[0]-Q[127] and input data from one of the two memory blocks 10, 20, dividing the 256-point input data into first data even items In_X[0]-In_X[127] and first data odd items In_Y[0]-In_Y[127]. Through the in-memory computing macro circuit 311, multiplication calculation is performed based on the first data odd items In_Y[0]-In_Y[127] and the weight coefficients omega[0]-omega[127] preloaded in the in-memory computing macro circuit 311 to obtain the first multiplication result corresponding to each stage. Next, through the Barrett reduction circuit 312, Barrett reduction is performed based on the first multiplication result D[0]-D[127] and the metadata Q[0]-Q[127] to obtain the first post-modulo results In_Y_multi[0]-In_Y_multi[127]. Then, through the modulo adder and modulo subtractor circuit 313, modulo addition and modulo subtraction operations are performed with the metadata Q[0]-Q[127], the first data even items In_X[0]-In_X[127], and the first post-modulo results In_Y_multi[0]-In_Y_multi[127] to calculate the first modadd results NTT_OUT0, NTT_OUT2, . . . , NTT_OUT254 and the first modsub results NTT_OUT1, NTT_OUT3, . . . , NTT_OUT255, and the first modadd results NTT_OUT0, NTT_OUT2, . . . , NTT_OUT254 and the first modsub results NTT_OUT1, NTT_OUT3, . . . , NTT_OUT255 are output to the sorting circuit 40, and stored in the other one of the two memory blocks 10, 20 through the sorting circuit 40 after output. The flexible bit-width NTT stage circuit 30 repeatedly performs a plurality of stages until the calculation of all stages is completed (kyber=7, Dilithium=8).

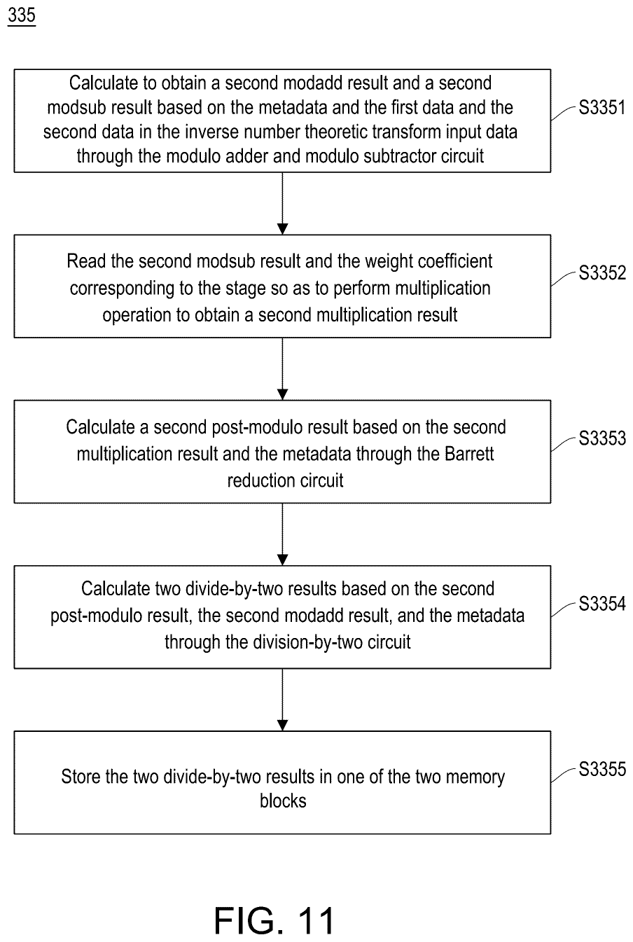

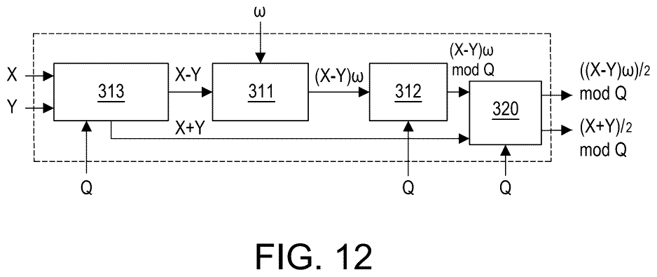

Next, an explanation will be provided for the step of performing the inverse NTT stage (INTT) calculation to obtain the calculation result as displayed in step S332 of the operation method 3 illustrated in FIG. 7 through the flexible bit-width NTT stage circuit 30. FIG. 11 is a flowchart illustrating performing inverse NTT stage (INTT) calculation as displayed in step S335 of the operation method 3 for flexibly performing number theoretic transform according to an embodiment of the disclosure. FIG. 12 is a schematic diagram illustrating performing inverse NTT stage (INTT) calculation as displayed in step S335 of the operation method 3 for flexibly performing number theoretic transform according to an embodiment of the disclosure. The INTT calculation in FIG. 11 and FIG. 12 may be performed by the control logic circuit 50 of the operation device 1 in FIG. 1, where the INTT calculation includes steps S3351-S3355. In the following, please refer to FIG. 1, FIG. 11, and FIG. 12 at the same time.

In step S3351, through the modulo adder and modulo subtractor circuit 313, calculation is performed to obtain a second modadd result X+Y and a second modsub result X−Y corresponding to the stage based on the metadata Q and the first data Y and the second data X in the sorted inverse number theoretic transform input data obtained by sorting the input data through the sorting circuit 40 in step 334.

In step S3352, through the in-memory computing macro circuit 311, the second modsub result X−Y and the weight coefficient ω corresponding to the stage are read so as to perform multiplication operation (X−Y)*ω to obtain a second multiplication result (X−Y)ω. Specifically, an internal memory block 214 may store the weight coefficient ω corresponding to the stage, and through the in-memory computing macro circuit 311, the second modsub result X−Y and a plurality of weight coefficients ω are read to calculate the second multiplication result (X−Y)ω.

In step S3353, through the Barrett reduction circuit 312, the metadata Q is read, and based on the second multiplication result (X−Y)ω and the metadata Q, a second post-modulo result (X−Y)ω mod Q is calculated.

In step S3354, through the division-by-two circuit 320, the two divide-by-two results ((X−Y)ω)/2 mod Q, (X+Y)/2 mod Q are calculated based on the second post-modulo result (X−Y)ω mod Q, the second modadd result X+Y, and the metadata Q.

In step S3355, the two divide-by-two results ((X−Y)ω)/2 mod Q, (X+Y)/2 mod Q are stored in one of the two memory blocks 10, 20.

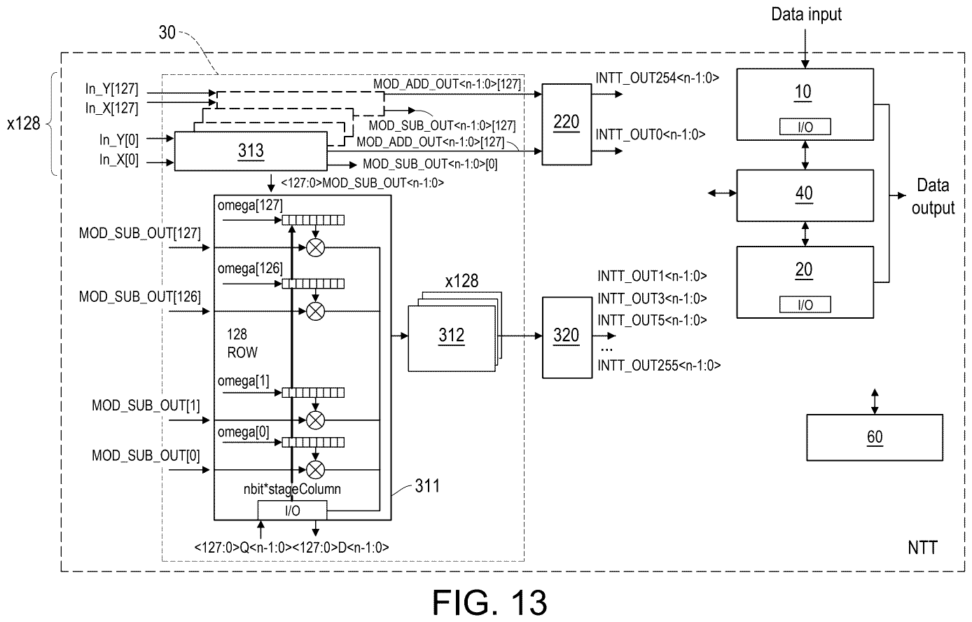

FIG. 13 is an architecture diagram illustrating a flexible bit-width 256-point inverse NTT stage circuit INNT according to an embodiment of the disclosure. As shown in FIG. 13, through the sorting circuit 40, the input data stored in one of the two memory blocks 10, 20 is rearranged to obtain sorted inverse number theoretic transform input data, which is then input to the flexible bit-width NTT stage circuit 30. The sorted 256-point inverse number theoretic transform input data is divided into the first data even items In_X[0]-In_X[127] and the first data odd items In_Y[0]-In_Y[127].

On one hand, through the modulo adder and modulo subtractor circuit 313, and based on the metadata Q[0]-Q[127], the first data even items In_X[0]-In_X[127] and the first data odd items In_Y[0]-In_Y[127], modadd operation is calculated to output the second modadd results MOD_ADD_OUT[0]-MOD_ADD_OUT[127], and the second modadd results MOD_ADD_OUT[0]-MOD_ADD_OUT[127] are calculated through the division-by-two circuit 320 to obtain the division-by-two result even items INTT_OUT0, INTT_OUT2, . . . , INTT_OUT254.

On the other hand, through the modulo adder and modulo subtractor circuit 313, and based on the metadata Q[0]-Q[127], the first data even items In_X[0]-In_X[127] and the first data odd items In_Y[0]-In_Y[127], modsub operation is calculated to output the second modsub results MOD_SUB_OUT[0]-MOD_SUB_OUT[127], and then through the in-memory computing macro circuit 311, the Barrett reduction circuit 312, and the division-by-two circuit 320, the division-by-two result odd items INTT_OUT1, INTT_OUT3, . . . , INTT_OUT255 are calculated. The flexible bit-width butterfly operation circuit 310 outputs the division-by-two result even items INTT_OUT0, INTT_OUT2, . . . , INTT_OUT254 and the division-by-two result odd items INTT_OUT1, INTT_OUT3, . . . , INTT_OUT255, and stores them in the other one of the two memory blocks 10, 20. The flexible bit-width NTT stage circuit 30 repeatedly performs a plurality of stages until the calculation of all stages is completed (kyber=7, Dilithium=8).

In the technology of the operation device 1 and operation method 3 for flexibly performing number theoretic transform disclosed in the disclosure, the data flow may, according to the requirements of number theoretic transform (NTT) or inverse number theoretic transform (INTT), be computed by the flexible bit-width NTT stage circuit 30, then sorted through the sorting circuit 40 before being written into the memory block, or be read from the memory block, sorted through the sorting circuit 40, and then transmitted to the flexible bit-width NTT stage circuit 30 for calculation. The memory blocks for calculation and writing are used alternately, and after completing the number of stages corresponding to the required points for NTT/INTT, the final result is output from the memory block where the last writing is completed.

The computing technology proposed by the disclosure may achieve the implementation of a flexible bit-width universal NTT/INTT hardware circuit. From the mathematical algorithm perspective, it flexibly implements Barrett reduction, and uses n-bit mod modulo adder and modulo subtractor circuit 313 to process modulo addition and modulo subtraction operations and n-bit division-by-two circuit 320 to process division operations, thereby achieving the purpose of flexible bit-width, and enabling the flexible bit-width NTT stage circuit 30 of the disclosure to be applied to encryption and decryption algorithms with different bit-widths and modulus Q values by changing internal parameters.

In summary, the operation device and operation method for flexibly performing number theoretic transform provided by the disclosure may use the flexible bit-width n-bit modulo adder and modulo subtractor circuit, the Barrett reduction circuit, the division-by-two circuit, and the NTT stage circuit composed of the in-memory computing macro circuit for performing multiplication operations, in conjunction with the dual memory buffers for data exchange and the sorting circuit to achieve flexible bit-width NTT stage operation.

What is claimed is:

1. An operation device for flexibly performing number theoretic transform, comprising:
two memory blocks, wherein one of the two memory blocks is configured to store metadata;
a flexible bit-width NTT stage circuit, having a plurality of weight coefficients corresponding to each stage, and comprising a plurality of flexible bit-width butterfly operation circuits;
a sorting circuit, coupled to the two memory blocks and the flexible bit-width NTT stage circuit; and
a control logic circuit, coupled to the flexible bit-width NTT stage circuit, and configured to generate a control signal to enable the flexible bit-width NTT stage circuit to sequentially perform an NTT stage operation on all the flexible bit-width butterfly operation circuits, wherein the NTT stage operation comprises an NTT stage calculation and an inverse NTT stage calculation;
wherein the flexible bit-width NTT stage circuit reads the metadata and input data from the one of the two memory blocks;
wherein when the NTT stage operation is the NTT stage calculation, the flexible bit-width NTT stage circuit performs the NTT stage calculation on the metadata and the input data to obtain a calculation result, the sorting circuit sorts the calculation result to obtain a sorting result of the calculation result, and the other one of the two memory blocks stores the sorting result;
wherein when the NTT stage operation is the inverse NTT stage calculation, the sorting circuit sorts the input data to obtain sorted inverse number theoretic transform input data, the flexible bit-width NTT stage circuit performs the inverse NTT stage calculation on the inverse number theoretic transform input data and the metadata to obtain the calculation result, and the other one of the two memory blocks stores the calculation result; and
wherein the flexible bit-width NTT stage circuit repeatedly performs a calculation of the number of stages corresponding to the number of points required for the NTT stage operation, and the flexible bit-width NTT stage circuit outputs a number theoretic transform result from the memory block that last receives data among the two memory blocks.

2. The operation device according to claim 1, wherein each of the flexible bit-width butterfly operation circuits comprises an in-memory computing macro circuit, a Barrett reduction circuit, and a modulo adder and modulo subtractor circuit, the in-memory computing macro circuit has internal parameters, and is configured to preload the weight coefficients corresponding to each stage in the flexible bit-width NTT stage circuit, and when the NTT stage operation is the NTT stage calculation, the flexible bit-width NTT stage circuit is further configured to:
read first data in the input data and the weight coefficient corresponding to the stage so as to perform a multiplication operation to obtain a first multiplication result corresponding to the stage through the in-memory computing macro circuit,
perform Barrett reduction to obtain a first post-modulo result based on the first multiplication result and the metadata through the Barrett reduction circuit, and
calculate a first modadd result and a first modsub result based on the metadata, second data and the first post-modulo result, and output the first modadd result and the first modsub result to the sorting circuit through the modulo adder and modulo subtractor circuit.

3. The operation device according to claim 1, wherein each of the flexible bit-width butterfly operation circuits comprises an in-memory computing macro circuit, a Barrett reduction circuit, and a modulo adder and modulo subtractor circuit, the in-memory computing macro circuit has internal parameters, and is configured to preload the weight coefficients corresponding to each stage in the flexible bit-width NTT stage circuit, the flexible bit-width NTT stage circuit further comprises a division-by-two circuit, and when the NTT stage operation is the inverse NTT stage calculation, the flexible bit-width NTT stage circuit is further configured to:
calculate to obtain a second modadd result and a second modsub result corresponding to the stage based on the metadata and first data and second data in the inverse number theoretic transform input data through the modulo adder and modulo subtractor circuit,
read the second modsub result and the weight coefficient corresponding to the stage so as to perform a multiplication operation to obtain a second multiplication result through the in-memory computing macro circuit,
perform Barrett reduction based on the second multiplication result and the metadata to obtain a second post-modulo result through the Barrett reduction circuit,
calculate two divide-by-two results based on the second post-modulo result, the second modadd result, and the metadata, and output the two divide-by-two results to one of the two memory blocks through the division-by-two circuit.

4. The operation device according to claim 2, wherein the Barrett reduction circuit is further configured to receive a selection value to select different Barrett reduction modules.

5. The operation device according to claim 3, wherein the Barrett reduction circuit is further configured to receive a selection value to select different Barrett reduction modules.

6. The operation device according to claim 2, wherein the Barrett reduction module uses CRYSTAL-Kyber algorithm or CRYSTAL-Dilithium algorithm.

7. The operation device according to claim 3, wherein the Barrett reduction module uses CRYSTAL-Kyber algorithm or CRYSTAL-Dilithium algorithm.

8. An operation method for flexibly performing number theoretic transform, adapted for an operation device, wherein the operation device comprises two memory blocks, a flexible bit-width NTT stage circuit, a sorting circuit, and a control logic circuit, the flexible bit-width NTT stage circuit comprises a plurality of flexible bit-width butterfly operation circuits, and the operation method for flexibly performing number theoretic transform comprises:
storing metadata in one of the two memory blocks;
generating a control signal through the control logic circuit to enable the flexible bit-width NTT stage circuit to sequentially perform an NTT stage operation on all the flexible bit-width butterfly operation circuits, wherein the NTT stage operation comprises an NTT stage calculation and an inverse NTT stage calculation, and the steps of the NTT stage operation comprise:
reading the metadata and input data from the one of the two memory blocks;
when the NTT stage operation is the NTT stage calculation, performing the NTT stage calculation on the metadata and the input data to obtain a calculation result through the flexible bit-width NTT stage circuit, sorting the calculation result to obtain a sorting result of the calculation result through the sorting circuit, and storing the sorting result in the other one of the two memory blocks; and
when the NTT stage operation is the inverse NTT stage calculation, sorting the input data to obtain sorted inverse number theoretic transform input data through the sorting circuit, performing the inverse NTT stage calculation on the inverse number theoretic transform input data and the metadata to obtain the calculation result through the flexible bit-width NTT stage circuit, and storing the calculation result in the other one of the two memory blocks; and
repeatedly performing a calculation of the number of stages corresponding to the number of points required for the NTT stage operation through the flexible bit-width NTT stage circuit; and
outputting a number theoretic transform result from the memory block that last receives data among the two memory blocks.

9. The operation method according to claim 8, wherein each of the flexible bit-width butterfly operation circuits comprises an in-memory computing macro circuit, a Barrett reduction circuit, and a modulo adder and modulo subtractor circuit, when the NTT stage operation is the NTT stage calculation, the step of performing the NTT stage calculation on the metadata and the input data to obtain the calculation result through the flexible bit-width NTT stage circuit comprises:
initializing internal parameters of the in-memory computing macro circuit, and preloading a plurality of weight coefficients corresponding to each stage in the flexible bit-width NTT stage circuit;
reading first data in the input data and the weight coefficient corresponding to the stage so as to perform a multiplication operation to obtain a first multiplication result corresponding to the stage through the in-memory computing macro circuit;
performing Barrett reduction to obtain a first post-modulo result based on the first multiplication result and the metadata through the Barrett reduction circuit; and
calculating a first modadd result and a first modsub result based on the metadata, second data, and the first post-modulo result, and outputting the first modadd result and the first modsub result to the sorting circuit through the modulo adder and modulo subtractor circuit.

10. The operation method according to claim 8, wherein each of the flexible bit-width butterfly operation circuits comprises an in-memory computing macro circuit, a Barrett reduction circuit, and a modulo adder and modulo subtractor circuit, the flexible bit-width NTT stage circuit further comprises a division-by-two circuit, when the NTT stage operation is the inverse NTT stage calculation, the step of performing the NTT stage operation on the metadata and the input data to obtain the calculation result comprises:
initializing internal parameters of the in-memory computing macro circuit, and preloading a plurality of weight coefficients corresponding to each stage in the flexible bit-width NTT stage circuit;
calculating to obtain a second modadd result and a second modsub result corresponding to the stage based on the metadata and first data and second data in the inverse number theoretic transform input data through the modulo adder and modulo subtractor circuit;
reading the second modsub result and the weight coefficient corresponding to the stage so as to perform a multiplication operation to obtain a second multiplication result through the in-memory computing macro circuit;
reading the metadata, and performing Barrett reduction to obtain a second post-modulo result based on the second multiplication result and the metadata through the Barrett reduction circuit;
calculating two divide-by-two results based on the second post-modulo result, the second modadd result, and the metadata, and outputting the two divide-by-two results to one of the two memory blocks through the division-by-two circuit.

11. The operation method according to claim 9, further comprising:
inputting a selection value to the Barrett reduction circuit to select different Barrett reduction modules.

12. The operation method according to claim 10, further comprising:
inputting a selection value to the Barrett reduction circuit to select different Barrett reduction modules.

13. The operation method according to claim 9, wherein the Barrett reduction module uses CRYSTAL-Kyber algorithm or CRYSTAL-Dilithium algorithm.

14. The operation method according to claim 10, wherein the Barrett reduction module uses CRYSTAL-Kyber algorithm or CRYSTAL-Dilithium algorithm.
